(19) United States
(12) Patent Application Publication
(10) Pub. No.: US 2026/0138626 A1
(43) Pub. Date: May 21, 2026

(54) SYSTEM AND METHOD OF ALIGNING MULTIPLE VEHICLES PERCEPTION DATA

(71) Applicant: GM Global Technology Operations LLC, Detroit, MI (US)

(72) Inventors: Bo Yu, Troy, MI (US); Gui Chen, Sterling Heights, MI (US); Milan Kumar Biswal, Las Cruces, NM (US); Joon Hwang, Pflugerville, TX (US)

(21) Appl. No.: 18/950,572

(22) Filed: Nov. 18, 2024

(51) Int. Cl. B60W 50/06; B60W 60/00; G01C 21/00; G06T 7/55

(52) U.S. Cl. CPC B60W 50/06; B60W 60/001; G01C 21/3811; G01C 21/3841; G06T 7/55; B60W 2556/50; G06T 2207/10028; G06T 2207/30252

(57) ABSTRACT

A method and system of aligning multiple vehicle perception data. The system is configured to execute the method including the steps of receiving perception data observed by a plurality of vehicles, processing the perception data to create feature points observed by the plurality of vehicles, determining matching feature points observed by each of the plurality of vehicles, determining an average offset between the matching feature points observed by each of the plurality of vehicles, reiterating perception data alignment until the average offset is below a predetermined threshold, using the average offset in a factor graph optimization to align multiple vehicle perception data, and updating a map database with the aligned perception data. The updated map data may be communicated to an autonomous vehicle for vehicle operations.

### INTRODUCTION

The present disclosure generally relates to autonomous vehicles having perception systems, and more particularly to a system and method of aligning perception data gathered by a plurality of vehicles.

Modern vehicles capable of partial or full driving automation are generally referred to as autonomous vehicles. Such autonomous vehicles have intelligent systems, also referred to as smart systems, such as Advanced Driver Assistance Systems (ADAS) and/or Automated Driving Systems (ADS) that reside onboard the vehicles and are used to enhance or automate functions of various vehicle systems.

Smart systems have one or more control modules that are configured to receive and process information gathered by the vehicle external sensors. The vehicle external sensors include, but are not limited to, cameras, radar, and LiDAR, which may be mounted on the exterior of the vehicle or in an interior compartment of the vehicle and are configured to gather information on the exterior surrounding environment of the vehicle. The gathered information is also referred to as perception data. The one or more control modules process the perception data to detect and identify objects around the vehicle, including, but are not limited to, surrounding vehicles, pedestrians, road configurations, traffic signs, landmarks, and road markings.

The detected and identified objects are used by the smart system for partial or full automation of the vehicle. Since perception data collected from a single smart system equipped vehicle is subject to sensor errors, perception data gathered by a plurality of smart system equipped vehicles for a section of a roadway or area may be pooled and processed for greater accuracy. Thus, while current smart systems achieve their intended purpose, there is a need for a new and improved system and method of aligning perception data gathered by a plurality of vehicles to improve accuracy.

### SUMMARY

According to several aspects, a method of aligning multiple vehicle perception data is provided. The method includes receiving perception data observed by a plurality of vehicles; processing the perception data to create feature points observed by the plurality of vehicles; determining matching pairs of feature points observed by the plurality of vehicles; determining an offset between each of the matching pairs of feature points; determining an average offset based on the offsets between each of the matching pairs of feature points; aligning the perception data by generating a factor graph using the average offset to represent a landmark offset relation between the plurality of vehicles; updating a map database with the aligned perception data; and operating an autonomous vehicle based on the updated map database.

In an additional aspect of the present disclosure, the matching pairs of feature points, the offset between each of the matching pairs of feature points, and the average offset are determined for each of the plurality of vehicles

In another aspect of the present disclosure, the method further includes receiving location data and time stamp data relating to the perception data observed by each of the plurality of vehicles. The average offset is determined by:

$$avg\_off ( {O}_{{v}_{i} {t}_{k}} , {V}_{j} ) = \frac{{\sum }_{i} {\sum }_{m} offset ( {P}_{i , l} , {P}_{j , m} )}{n}$$

$$wherein :$$

$$avg\_offset = offset by which a vehicle i can be aligned with a vehicle j at a timestamp {t}_{k}$$

$${O}_{{v}_{i} {t}_{k}} = Vehicle i ’ s observation at {t}_{k}$$

$${V}_{j} = vehicle j ’ s trajectory in the vicinity$$

$${P}_{i , l} = landmark point l observed by vehicle i at {t}_{k}$$

$${P}_{j , m} = landmark point m in the vicinity , observed by vehicle j$$

$${P}_{i , l} , {P}_{j , m} = a determined matching pair calculated by local registration$$

$$n = the number of landmarks in {O}_{{v}_{i} {t}_{k}} .$$

In another aspect of the present disclosure, the factor graph includes a plurality of variable nodes, a plurality of factor nodes, and a plurality of edges linking variable nodes and factor nodes. At least one of the plurality of variable nodes includes the average offset representing the landmark offset relation between at two of the plurality of vehicles. At least one of the plurality of factor nodes includes a relative pose between the plurality of vehicles.

In another aspect of the present disclosure, the factor graph includes at least 3 constraints. The constraints include a pose of one of the plurality of vehicles is within a first predetermined distance from an original location of the one of the plurality of vehicles; the pose of the one of the plurality of vehicles at each subsequent time stamp is withing a second predetermined distance from an original pose of the one of the plurality of vehicles; and a landmark observed by the one of the plurality of vehicles is aligned with a landmark observed by another one of the plurality of vehicles.

In another aspect of the present disclosure, determining an average offset based on the offsets between each of the matching pairs of feature points includes determining the average offset is greater than a predetermined average offset threshold. The method further includes shifting the matching pairs of feature points with respect to the average offset in response to the average offset is greater than a predetermined average offset threshold and reiterate the method until the average offset is less than the predetermined average offset threshold.

In another aspect of the present disclosure, the plurality of vehicles includes a first vehicle and a second vehicle. Processing the perception data includes creating first feature points observed by the first vehicle and second feature points observed by the second vehicle. Determining matching pairs of feature points includes determining matching pairs of first feature points and second feature points. Determining an offset between each of the matching pairs of feature points includes: (i) determining an average offset between a first matching pair of a first feature points and a second feature point, and (ii) shifting the first feature point to the second feature point based on the average offset.

In another aspect of the present disclosure, the method further includes determining the average offset between the first matching pair of the first feature points and the second feature points is above a predetermined average offset threshold, and reiterating (i) and (ii) until the average offset is below the predetermined threshold.

In another aspect of the present disclosure, determining matching pairs of feature points observed by the plurality of vehicles are determined for each feature point observed by each of the plurality of vehicles.

According to several aspects, a system of aligning multiple vehicle perception data is provided. The system includes a server communication system configured to receive perception data from a plurality of vehicles, a map database, and a server controller in electrical communication with the server communication system and the map database. The server controller is configured to: receive perception data observed by a plurality of vehicles; process the perception data to create feature points observed by the plurality of vehicles; determine matching feature points observed by each of the plurality of vehicles; determine an average offset between the matching feature points observed by each of the plurality of vehicles; align the perception data by generating a factor graph using the average offset to represent a landmark offset relation between the plurality of vehicles; and update a map database with the aligned perception data.

In an additional aspect of the present disclosure, the perception data comprises landmarks, vehicle locations, and respective time stamps.

In another aspect of the present disclosure, determining an average offset based on the offsets between feature points includes determining the average offset is less than a predetermined offset threshold.

In another aspect of the present disclosure, aligning the perception data by generating a factor graph includes using the average offset to represent a landmark offset relation between the plurality of vehicles.

According to several aspects, system including a processor and a non-transitory computer readable medium having instructions stored thereon for aligning multiple vehicle perception data, that upon execution by the processor, cause the processor to: receive perception data observed by a plurality of vehicles; process the perception data to create feature points observed by the plurality of vehicles; determine matching feature points observed by each of the plurality of vehicles; determine an average offset between the matching feature points observed by each of the plurality of vehicles; align the perception data by generating a factor graph using the average offset to represent a landmark offset relation between the plurality of vehicles; update a map database with the aligned perception data; and communicate updated map data to an autonomous vehicle for operation of the autonomous vehicle.

In an additional aspect of the present disclosure, cause the processor to further determine an average offset is below a predetermined threshold before align the perception data by generating the factor graph.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way

FIG. 1 is functional diagram of a vehicle having a smart system, according to an exemplary embodiment;

FIG. 2 is a plan view of a plurality of vehicles having smart systems traveling on a roadway, according an exemplary embodiment;

FIG. 3 is a block flow diagram of a Method of aligning the perception data collected by a plurality of vehicles, according to an exemplary embodiment;

FIG. 4 is a detailed block flow diagram of a block shown in FIG. 3, according to an exemplary embodiment;

FIG. 5 is an illustration of the perception data gathered by the plurality of vehicles of FIG. 2, according to an exemplary embodiment;

FIG. 6 is an illustration of the perception data gathered by one of the vehicles compared to perception data gathered by the other vehicles, according to an exemplary embodiment; and

FIG. 7 is an illustration of an exemplary factor graph, according to an exemplary embodiment.

### DETAILED DESCRIPTION

The following description is merely exemplary in nature and is not intended to limit the present disclosure, application, or uses. The illustrated embodiments are disclosed with reference to the drawings, wherein like numerals indicate corresponding parts throughout the several drawings. The figures are not necessarily to scale and some features may be exaggerated or minimized to show details of particular features. The specific structural and functional details disclosed are not intended to be interpreted as limiting, but as a representative basis for teaching one skilled in the art as to how to practice the disclosed concepts.

As used herein, the terms module, component module, control module, or controller refer to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may conduct a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

The connecting lines shown in the various figures contained herein are intended to represent example functional relationships and/or physical couplings between the various elements. Conventional techniques may be used for signal processing, data transmission, signaling, control, and other functional aspects of the systems (and the individual operating components of the systems) may not be described in detail herein. It should be noted that many alternative or additional functional relationships or physical connections may be present in an embodiment of the present disclosure.

Although the terms first, second, third, etc. may be used herein to describe various elements, components, portions, and/or sections, these elements, components, portions, and/or sections should not be limited by these terms, unless otherwise indicated. These terms are used to distinguish one elements, components, portions, and/or sections from another elements, components, portions, and/or sections.

In crowd-sourced map construction, perception data gathered by a plurality of smart vehicles for a roadway or area are processed to detect and identify objects, which includes lane lines, stop signs, etc. The location of the objects and identification of the objects are updated in the crowd-sourced map data. The updated crowd-sourced map data are communicated to smart vehicles for improved operations as the smart vehicles travels through the section of roadway or area. The crowd-sourced perception data may have slight discrepancies in the location of the detected objects caused by variables such as external sensor capabilities, positions of the smart vehicle on the roadway, and accuracy of GPS. Therefore, a common step in crowd-sourced map construction is to align the perception data gathered by one vehicle with perception data gathered by another vehicle. The following disclosure provides a system and method of aligning perception data gathered by a plurality of vehicles.

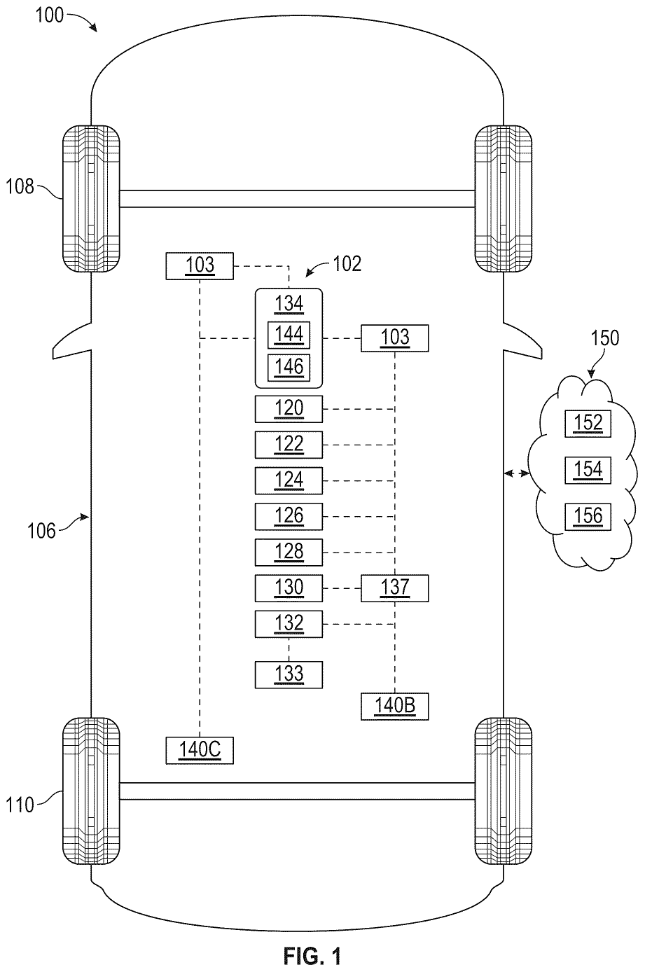

FIG. 1 is a functional diagram of a vehicle 100 having a smart system 102, such as an Advance Driver Assistance System (ADAS) and/or an Automated Driving System (ADS), capable of operating from Level 0 (no driving automation) to Level 5 (full driving automation) in accordance with SAE J3016 levels of driving automation. The vehicle 100 is also referred to as an autonomous vehicle 100. The vehicle 100 generally includes a body 106, front wheels 108, and rear wheels 110. The body 106 substantially encloses the vehicle systems and components of the vehicle 100. The front wheels 108 and the rear wheels 110 are each rotationally coupled to the body 106 near a respective corner of the body 106. Although the connected vehicle 100 is shown as a sedan, it is envisioned that that connected vehicle 100 may be another type of on-road vehicle, such as a pickup truck, a coupe, a sport utility vehicle (SUVs), a recreational vehicle (RVs), and a motorcycle.

As shown, the vehicle 100 generally includes a smart system 102 such as ADAS and/or ADS, a propulsion system 120, a transmission system 122, a steering system 124, a brake system 126, a perception system 128, a vehicle communication system 130, and a global navigation satellite system (GNSS) 132. GNSS is an umbrella term that covers all global satellite positioning systems. The vehicle systems 120, 122, 124, 126, 128, 130 and 132 are in communication with a control module 134. The vehicle 100 may also include various vehicle actuators 133 in communications with the control module 134 and with selected vehicle systems. The various vehicle actuators 133 are configured to selectively operate components of the vehicle systems 120, 122, 124, 126, 128, 130 based on commands from the control module 134.

The smart system 102 includes a vehicle control module 134 in communication with one or more vehicle systems and vehicle actuators using a Controller Area Network (CAN) and/or ethernet. The vehicle control module 134 may be configured to implement a method of feature matching for associating vehicle perception data, as described in detail below. The method can be implemented on the vehicle control module to process one vehicle's sensor data, it can also be implemented on the cloud to process multiple vehicles' sensor data.

The control module 134 includes at least one processor 144 and a non-transitory computer readable storage device or media 146. The non-transitory computer readable storage device or media 146 includes machine-readable instructions that when executed by the processor 144, causes the processors 144 to execute the Method 300 described below and to control the vehicle 100 in partial or full autonomous mode. The processor 144 may be a custom made or commercially available processor, a central processing unit (CPU), a graphics processing unit (GPU), an auxiliary processor among several processors associated with the control module 134, a semiconductor-based microprocessor (in the form of a microchip or chip set), a macro processor, a combination thereof, or generally a device for executing instructions. The vehicle computer readable storage device or media 146 may include volatile and nonvolatile storage in read-only memory (ROM), random-access memory (RAM), and keep-alive memory (KAM), for example. KAM is a persistent or non-volatile memory that may be used to store various operating variables while the processor 144 is powered down. The vehicle computer-readable storage device or media 146 of the control module 134 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the control module 134 in controlling the autonomous vehicle 100.

The perception system 128 is configured to gather information, perception data, on the external environment surrounding the vehicle 100. In a non-limiting exemplary embodiment, the perception system 128 may include one or more cameras arranged to capture images and/or videos of the environment adjacent to all sides of the vehicle 100. The one or more cameras may include a front-facing camera, a rear-facing camera, and/or two side-facing cameras. The one or more cameras may have various image sensor including, for example, charge-coupled device (CCD) sensors, complementary metal oxide semiconductor (CMOS) sensors, and/or high dynamic range (HDR) sensors. The one or more cameras may have various lens types including, for example, wide-angle lenses and/or narrow-angle lenses are also within the scope of the present disclosure.

The GNSS 132 is configured to determine a geographical location of the vehicle 100. In an exemplary embodiment, the GNSS 132 includes a global positioning system (GPS). In a non-limiting example, the GPS includes a GPS receiver antenna (not shown) and a GPS controller (not shown) in electrical communication with the GPS receiver antenna. The GPS receiver antenna receives signals from a plurality of satellites, and the GPS controller calculates the geographical location of the vehicle 100 based on the signals received by the GPS receiver antenna. In an exemplary embodiment, the GNSS 132 additionally includes a map. The map contains information about infrastructure such as municipality borders, roadways, railways, sidewalks, buildings, and the like. Therefore, the geographical location of the vehicle 100 is contextualized using the map information.

The vehicle communication system 130 is used by the vehicle control module 134 to communicate with other systems external to the vehicle 100. For example, the vehicle communication system 130 includes capabilities for communication with vehicles (“V2V” communication), infrastructure (“V2I” communication), remote systems at a remote call center (e.g., ON-STAR by GENERAL MOTORS) and/or personal devices. In general, the term vehicle-to-everything communication (“V2X” communication) refers to communication between the vehicle 100 and any remote system (e.g., vehicles, infrastructure, and/or remote systems). In certain embodiments, the vehicle communication system 130 is a wireless communication system configured to communicate via a wireless local area network (WLAN) using IEEE 802.11 standards or by using cellular data communication (e.g., using GSMA standards, such as, for example, SGP.02, SGP.22, SGP.32, and the like). Accordingly, the vehicle communication system 130 may further include an embedded universal integrated circuit card (eUICC) configured to store at least one cellular connectivity configuration profile, for example, an embedded subscriber identity module (eSIM) profile.

The vehicle communication system 130 is further configured to communicate via a personal area network (e.g., BLUETOOTH) and/or near-field communication (NFC). However, additional, or alternate communication methods, such as a dedicated short-range communications (DSRC) channel and/or mobile telecommunications protocols based on the 3rd Generation Partnership Project (3GPP) standards, are also considered within the scope of the present disclosure. DSRC channels refer to one-way or two-way short-range to medium-range wireless communication channels specifically designed for automotive use and a corresponding set of protocols and standards. The 3GPP refers to a partnership between several standards organizations which develop protocols and standards for mobile telecommunications. 3GPP standards are structured as “releases”. Thus, communication methods based on 3GPP release 14, 15, 16 and/or future 3GPP releases are considered within the scope of the present disclosure. Accordingly, the vehicle communication system 130 may include one or more antennas and/or communication transceivers for receiving and/or transmitting signals, such as cooperative sensing messages (CSMs). The vehicle communication system 130 is configured to wirelessly communicate information between the vehicle 100 and another vehicle. Further, the vehicle communication system 130 is configured to wirelessly communicate information between the vehicle 100 and infrastructure or other vehicles. It should be understood that the vehicle communication system 130 may be integrated with the vehicle control module 134 (e.g., on a same circuit board with the vehicle control module 134 or otherwise a part of the vehicle control module 134) without departing from the scope of the present disclosure.

With continued reference to FIG. 1, the cloud server system 150 includes a server controller 152 in electrical communication with a map database 154 and a server communication system 156. In a non-limiting example, the cloud server system 150 is located in a server farm, datacenter, or the like, and connected to the internet using the server communication system. The server controller 152 includes at least one server processor and a server non-transitory computer readable storage device or server media. The description of the type and configuration given above for the vehicle control module also applies to the server controller. In some examples, the server controller 152 may differ from the vehicle control module 134 in that the server controller 152 is capable of a higher processing speed, includes more memory, includes more inputs/outputs, and/or the like. In a non-limiting example, the server processor and server media of the server controller 152 are similar in structure and/or function to the processor and the media of the vehicle control module 134, as described above.

The map database 154 is used to store map data about roadways, including, for example, lane line map data, as will be discussed in greater detail below. The server communication system 156 is used to communicate with external systems, such as, for example, the vehicle control module 134 via the vehicle communication system. In a non-limiting example, the server communication system 156 is similar in structure and/or function to the vehicle communication system of the vehicle system 130, as described above.

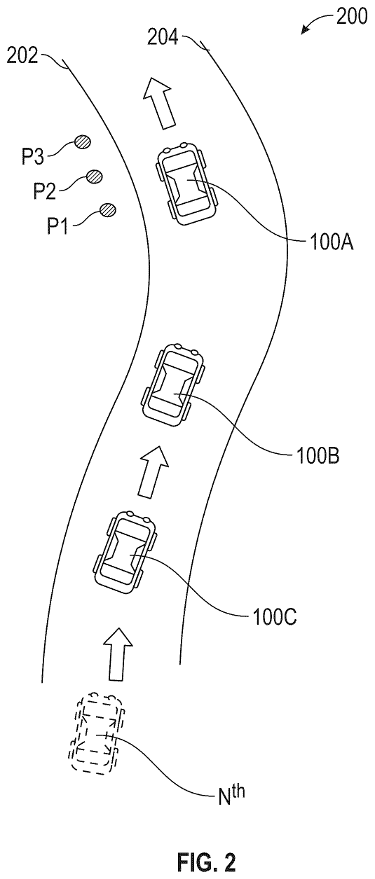

FIG. 2 is an illustration of a non-limiting example of a scenario in which a first smart vehicle 100A, a second smart vehicle 100B and a third smart vehicle 1000 are traveling on a roadway 200 defined between a first lane marker 202 and a second lane marker 204. For brevity, the first smart vehicle 100A, the second smart vehicle 100B, and the third smart vehicle 1000 are referred to as the first vehicle 100A, the second vehicle 100B, and the third smart vehicle 1000, respectively. While three vehicles are shown, it should be appreciated that the scenario may include up to N^{th} vehicles, where N is an integer greater than 3. Each of the location trajectories of the vehicles 100A, 100B, 1000 is determined by using the GNSS on the respective vehicles. In one example, the perception system 128 of the respective vehicles 100A, 100B, 1000 captures a plurality of images of the roadway and areas adjacent the roadway including landmarks. The control module of the respective vehicles utilizes a computer vision algorithm to identify feature points P₁, P₂, P₃ in the plurality of images of the roadway. The feature points P₁, P₂, P₃ may include the land markings, landmarks, traffic signs, road configuration and any other items typically found on a roadway. The communication system of each vehicle is configured to upload the respective perception data, the vehicle global location including vehicle trajectory, and a time stamp to the cloud server system 150.

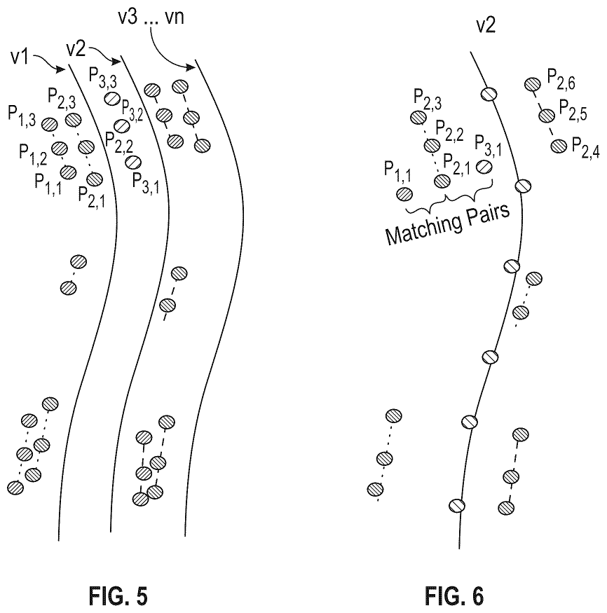

FIG. 5 is an illustration of the perception data gathered by each of the vehicles 100A, 100B, 100C. The trajectory V1 of the first vehicle 100A as determined by the GNSS of the first vehicle 100A is indicated by reference numeral V1 (trajectory V1). The trajectory V2 of the second vehicle as determined by the GNSS of the second vehicle 100B is indicated by reference numeral V2 (trajectory V2). The trajectory V3 of the third vehicle 1000 as determined by the GNSS of the third vehicle 1000 is indicated by reference numeral V3 (trajectory V3). The locations of the feature points P₁, P₂, P₃ as observed by the first vehicle 100A is indicated by reference numerals P_{1,1}, P_{1,2}, P_{1,3}, respectively. The locations of the feature points P₁, P₂, P₃ as observed by the second vehicle 100B is indicated by reference numerals P_{2,1}, P_{2,2}, P_{2,3}, respectively. The locations of the feature points P₁, P₂, P₃ as observed by the third vehicle 100C is indicated by reference numerals P_{3,1}, P_{3,2}, P_{3,3}, respectively.

Referring to FIG. 6, the offsets of the feature points P₁, P₂, P₃, as perceived by the first vehicle 100A, second vehicle 100B, and third vehicle 1000 are due, in part, to one or more of GNSS inaccuracy, sensor limitations, weather, obstructions, the relative locations of the vehicles 100A, 100B, 100C while gathering perception data, and other contributing factors. The collected perception data collected by the first vehicle 100A, the second vehicle 100B, and the third vehicle 100C are uploaded to the cloud server system 150. The cloud server system 150 is configured to associate and align the perception data gathered by a plurality of vehicles to improve the accuracy of a map database. The map database may be downloaded to smart vehicles to enhance and/or automate various vehicle functions.

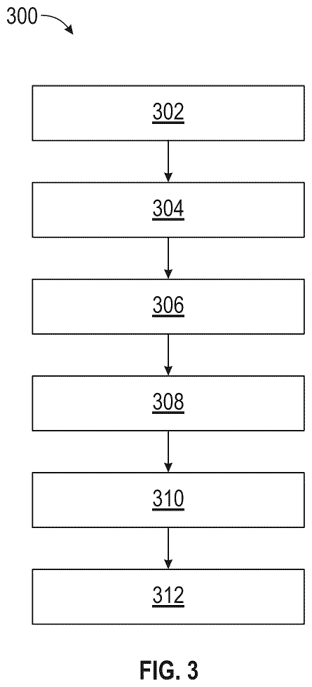

FIG. 3 is a block diagram of a method of aligning the perception data collected by a plurality of vehicles (Method 300). The Method 300 includes using computer vision features to collect perception data by a plurality of vehicles, local registration of feature points identified in the perception data, iterative perception data alignment, factor graph optimization to align multiple vehicle perception data and GPS location information (also referred to as trajectory information or GPS), update map data, and use updated map data to operate the vehicles.

At Block 302, a plurality of smart vehicles gather perception data on a portion of a roadway and/or area. The perception data, together with a time stamp of the data and vehicle trajectory, is communicated to a cloud server system 150. The perception data is processed by the cloud server system 150 to create feature points representing the observation of each the vehicles 100A, 100B, 100C. Observation means a set of perception data observed by the vehicle at time t. For example, observation Oₜ₂ includes timestamp t₂, trajectory location, feature points (i.e. lane points) (P_{2,1}, . . . , P_{2,6}). Feature points may include landmarks such as road signs, traffic signals, and other distinguishing features. Observed lane lines may be converted into feature points. In a non-limiting example, in a semantic map or on a vehicle's perception data set, a lane line may be represented by a polynomial, y=ax²+bx+c, in a smart vehicle's ego coordinate system. For each lane line, the polynomial representation is converted to feature points: (x1, y(x1)), (x2, y(x2)), (x3, y(x3)). In another exemplary embodiment, to determine a lane line map, the server controller may use a hill climbing algorithm, as described in U.S. application Ser. No. 17/930,503, titled “HILL CLIMBING ALGORITHM FOR CONSTRUCTING A LANE LINE MAP”, filed on Sep. 8, 2022, the entire contents of which is hereby incorporated by reference. It should be understood that any method for determining a mathematical equation describing one or more lane lines is within the scope of the present disclosure. The Method 300 proceeds to Block 304.

At Block 304, local registration is used to find the association between feature points (e.g. landmarks) observed by the vehicles. Registration means the feature points observed by one vehicle is associated (i.e. matched) with the feature points observed by the other vehicles. Local registration means regional feature point attributes such as line color, line type, line position, etc. are used in the association process to identify the matching feature points. Feature match pairs for each feature point (e.g. landmark) from each vehicle's perception data may be created by running a local registration method, such as feature matching, or point cloud registration. Referring to FIG. 5, for example, for V2's point P_{2,1}, there are a few matching pairs between P_{2,1} and all neighboring landmark points (e.g. P_{1,1}, P_{1,2}, P_{2,2}, P_{3,1}) near P_{2,1}. Potential matching pairs include (P_{2,1},P_{1,1}) and (P_{2,1}, P_{3,1})

Exemplary embodiments of methods of determining feature points on a lane line map and matching the feature points are described in U.S. application Ser. No. 18/359,017, titled “CROWD-SOURCING LANE LINE MAPS FOR A VEHICLE”, filed on Jul. 26, 2023, and U.S. Application No. TBD, titled “A SYSTEM AND METHOD OF FEATURE MATCHING FOR ASSOCIATING VEHICLE PERCEPTION DATA”, filed on November, TBD, 2024, the entire contents of which are hereby incorporated by reference.

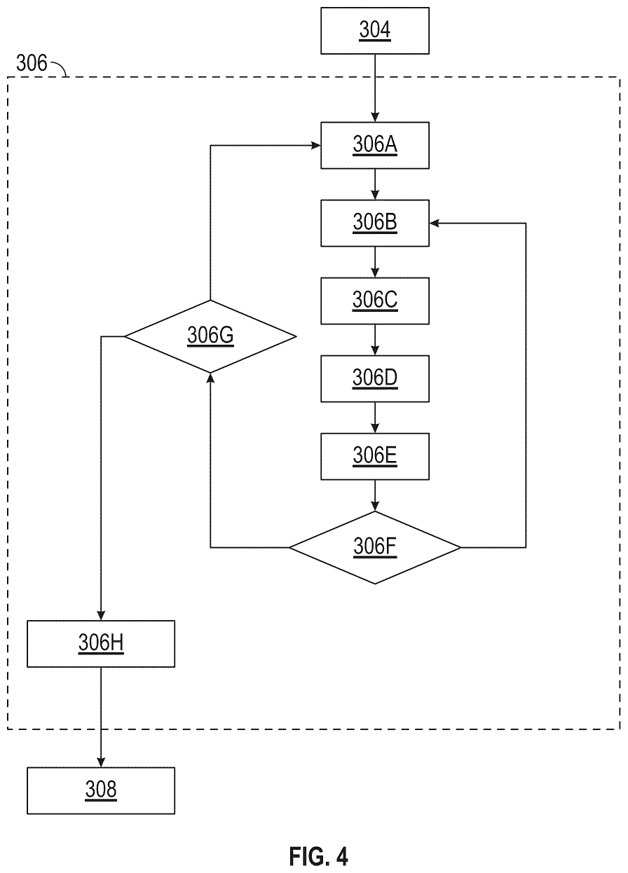

At Block 306, a simple heuristic iterative method is used to update each vehicle's GNSS positions and perception data geometry based on the local registration. In each iteration, minor adjustments are made to each vehicle's position as well as perception data geometry. The algorithm exits once a maximum number of iterations is reached or the adjustment (average offset) is less than a predetermined threshold, such as less than a 1 meter offset between a pair of matching feature points. In each iteration, for each vehicle and each observation, 1) the offset for each feature point matching pair is calculated, 2) the average offset of each observation's multiple landmark matching pairs is calculated, and 3) the average offset to the observation is applied so that the vehicle position and the perception data geometry is adjusted slightly by shifting the observed feature points closer based on the average offset. Each of the vehicles is processed through the iteration. The output of the Method 300 is that multiple vehicle's perception data are aligned with each other, with GNSS, and lane line points' geometry data updated. FIG. 4 is a detailed block flow diagram of Block 306.

Referring to FIG. 4, at Block 306A, the number of iterations for each vehicle an observation is tallied. Proceeding to Block 306B, the iteration is performed for each vehicle and each observation by the vehicle. Proceeding to Block 306C, for each vehicle and each observation, the offset for each feature point (e.g. landmark) matching pair is calculated. The following formula may be used to calculate the average of set.

$$avg\_off ( {O}_{{v}_{i} {t}_{k}} , {V}_{j} ) = \frac{{\sum }_{i} {\sum }_{m} offset ( {P}_{i , l} , {P}_{j , m} )}{n}$$

Wherein
Avg_offset—the offset by which vehicle i can be aligned with vehicle j at timestamp tₖ
Oᵥ_{ᵢ}ₜ_{ₖ}—Vehicle i's observation at tk
Vⱼ—another vehicle trajectory in the vicinity
P_{i,l}—Oᵥ_{ᵢ}ₜ_{ₖ}'s landmark point I
P_{j,m}—landmark point m in the vicinity, observed by another vehicle j
P_{i,l}, P_{j,m}—a matching pair calculated by local registration
n—the number of landmarks in Oᵥ_{ᵢ}ₜ_{ₖ}

Proceeding to Block 306D, for each vehicle and each observation, the average offset of each observation's multiple landmark matching pair is calculated. Proceeding to Block 306E, for each vehicle and each observation, the average offset to the observation is applied so that the vehicle position and the perception data geometry is adjusted. Proceeding to Block 306F, determine if all observations for each vehicle are processed. If all observations from all vehicles are processed, the iterative method proceeds to Block 306G. If not all observations from all vehicles are processed, the Method 300 proceeds to Block 306B to process the next vehicle's observations. At 306G and referring to FIG. 6, determine if the applied offset is less than a predetermined threshold, the applied offset is less than the predetermined threshold, the Method 300 proceeds to Block 306H. At 306H, the observations of the plurality of vehicles are aligned, however, the alignment may be improved. The Method moves to Block 308.

At Block 308, a Factor Graph Optimization (FGO) refines the aligned perception data from Block 306H and calculated the final optimized GNSS positions and perception data geometry. The FGO uses the output from Block 306 as an initial estimator of FGO variables for running the optimization process to calculate the optimized values of the variables such as GNSS positions, lane line geometry, road sign positions, etc. The initial output of Block 306 provides a good estimate of the initial values of the FGO variables and speeds up the process of FGO, which otherwise would be a time consuming process.

The factor graph 700 includes variables and constraints. The variables includes each vehicle's position in terms of latitude and longitude at each time stamp. The constraints or three types of factors includes: GPS constraint, in which the vehicle's pose shouldn't be far away from the vehicle's original GPS position; Pose constraint, in which the vehicle's pose at each time stamp shouldn't change significantly from its original pose; and Landmark constraint, in which the vehicle's observed landmark should be aligned with another vehicle's observed landmark. Multiple vehicle trajectories are optimized in one factor graph 700.

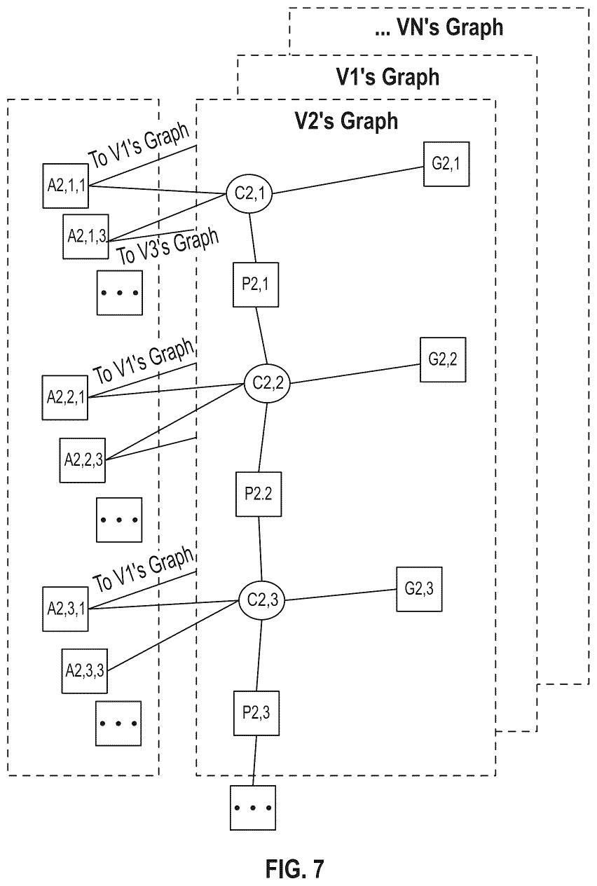

Referring to FIG. 7, is an illustration of an exemplary factor graph 700 for the second vehicle. The factor graph 700 may includes a plurality of variable nodes, a plurality of factor nodes, and a plurality of edges linking variable nodes and factor nodes. At least one of the plurality of variable nodes may include the average offset representing the landmark offset relation between at two of the plurality of vehicles. At least one of the plurality of factor nodes may include a relative pose between the plurality of vehicles. In a non-limiting example, C2,1, C2,2, C2,3 represent vehicle pose variables to be optimized for vehicle V2 at t₁, t₂, t₃. For example, C2 can represent Oₜ_{₂}. P_{2,1}, P_{2,2}, P_{2,3} represent vehicle pose factors which define the relative pose between (C2,1,C2,2), (C2,2, C2,3), (C2,3, C2,4). A2,1,1, A2,1,3, represents the landmark factors which help align V2's perception data with other the vehicles' perception data. For example, A2,2,1 represents the landmark offset relation between V2 and V1 at timestamp t₂; this constraint can be calculated based on the calculated average offset. The Method 300 proceeds to Block 310.

An exemplary embodiment of a method of a factor graph optimization-based method is described in U.S. application Ser. No. 18/530,686 titled “CROWD-SOURCING LANE LINE MAPS FOR A VEHICLE”, filed on Dec. 6, 2023, the entire contents of which is hereby incorporated by reference.

At Block 310, the map data is updated with the associated data and communicated to the vehicles. The Method 300 proceeds to Block 312.

At Block 312, the control module of the smart vehicles utilize the updated map data to execute a function of the smart system in operating the vehicle. As an example, a function of the smart system may include adjusting an operation the ADAS and/or ADS of the vehicle 100 such as lane-keeping and/or lane departure warning. As another example, the ADS may utilize the updated map data to adjust a path of the vehicle 100 for partial to full automated driving.

The description of the present disclosure is merely exemplary in nature and variations that do not depart from the general sense of the present disclosure are intended to be within the scope of the present disclosure. Such variations are not to be regarded as a departure from the spirit and scope of the present disclosure.

1. A method of aligning multiple vehicle perception data, comprising:
receiving perception data observed by a plurality of vehicles;
processing the perception data to create feature points observed by the plurality of vehicles;
determining matching pairs of feature points observed by the plurality of vehicles;
determining an offset between each of the matching pairs of feature points;
determining an average offset based on the offsets between each of the matching pairs of feature points;
aligning the perception data by generating a factor graph using the average offset to represent a landmark offset relation between the plurality of vehicles;
updating a map database with the aligned perception data; and
operating an autonomous vehicle based on the updated map database.

2. The method of claim 1, wherein the matching pairs of feature points, the offset between each of the matching pairs of feature points, and the average offset are determined for each of the plurality of vehicles.

3. The method of claim 2, further comprising:
receiving location data and time stamp data relating to the perception data observed by each of the plurality of vehicles; and
wherein the average offset is determined by:
$$avg\_off ( {O}_{{v}_{i} {t}_{k}} , {V}_{j} ) = \frac{{\sum }_{i} {\sum }_{m} offset ( {P}_{i , l} , {P}_{j , m} )}{n}$$
avg_offset=offset by which a vehicle i can be aligned with a vehicle j at a timestamp tₖ
Oᵥ_{ᵢ}ₜ_{ₖ}=Vehicle i's observation at tₖ
Vⱼ=vehicle j's trajectory in the vicinity
P_{i,l}=landmark point I observed by vehicle i at tₖ
P_{j,m}=landmark point m in the vicinity, observed by vehicle j
P_{i,l}, P_{j,m}=a determined matching pair calculated by local registration
n=the number of landmarks in Oᵥ_{ᵢ}ₜ_{ₖ}.

4. The method of claim 3, wherein the factor graph includes a plurality of variable nodes, a plurality of factor nodes, and a plurality of edges linking variable nodes and factor nodes;
wherein at least one of the plurality of variable nodes includes the average offset representing the landmark offset relation between at two of the plurality of vehicles; and
wherein at least one of the plurality of factor nodes includes a relative pose between the plurality of vehicles.

5. The method of claim 4, wherein the factor graph comprises at least 3 constraints, including:
a pose of one of the plurality of vehicles is within a first predetermined distance from an original location of the one of the plurality of vehicles;
the pose of the one of the plurality of vehicles at each subsequent time stamp is withing a second predetermined distance from an original pose of the one of the plurality of vehicles; and
a landmark observed by the one of the plurality of vehicles is aligned with a landmark observed by another one of the plurality of vehicles.

6. The method of claim 1, wherein determining an average offset based on the offsets between each of the matching pairs of feature points includes determining the average offset is greater than a predetermined average offset threshold; and
the method further includes:
shifting the matching pairs of feature points with respect to the average offset in response to the average offset is greater than a predetermined average offset threshold; and
reiterate the method until the average offset is less than the predetermined average offset threshold.

7. The method of claim 1, wherein the plurality of vehicles includes a first vehicle and a second vehicle;
wherein processing the perception data includes creating first feature points observed by the first vehicle and second feature points observed by the second vehicle;
wherein determining matching pairs of feature points includes determining matching pairs of first feature points and second feature points;
determining an offset between each of the matching pairs of feature points includes:
(i) determining an average offset between a first matching pair of a first feature points and a second feature point, and
(ii) shifting the first feature point to the second feature point based on the average offset.

8. The method of claim 7, further comprises:
determining the average offset between the first matching pair of the first feature points and the second feature points is above a predetermined average offset threshold;
and reiterating (i) and (ii) until the average offset is below the predetermined threshold.

9. The method of claim 1, wherein determining matching pairs of feature points observed by the plurality of vehicles are determined for each feature point observed by each of the plurality of vehicles.

10. The method of claim 1, wherein the factor graph comprises:
a pose of one of the plurality of vehicles is within a first predetermined distance from a GPS location of the one of the plurality of vehicles;
the pose of the one of the plurality of vehicles at each subsequent time stamp is withing a second predetermined distance from an original pose of the plurality of vehicles; and
an observed landmark is aligned with a landmark observed by another one of the plurality of vehicles.

11. A system for aligning multiple vehicle perception data, the system comprising:
a server communication system configured to receive perception data from a plurality of vehicles;
a map database;
a server controller in electrical communication with the server communication system and the map database, wherein the server controller is configured to:
receive perception data observed by a plurality of vehicles;
process the perception data to create feature points observed by the plurality of vehicles;
determine matching feature points observed by each of the plurality of vehicles;
determine an average offset between the matching feature points observed by each of the plurality of vehicles;
align the perception data by generating a factor graph using the average offset to represent a landmark offset relation between the plurality of vehicles; and
update a map database with the aligned perception data.

12. The system of claim 11, wherein the perception data comprises landmarks, vehicle locations, and respective time stamps.

13. The system of claim 12, wherein the factor graphs comprises at least 3 constraints, including:
a pose of one of the plurality of vehicles is within a first predetermined distance from a GPS location of the one of the plurality of vehicles;
the pose of the one of the plurality of vehicles at each subsequent time stamp is withing a second predetermined distance from an original pose of the plurality of vehicles; and
an observed landmark is aligned with a landmark observed by another one of the plurality of vehicles.

14. The system of claim 12, wherein the average offset is determined by:
$$avg\_off ( {O}_{{v}_{i} {t}_{k}} , {V}_{j} ) = \frac{{\sum }_{i} {\sum }_{m} offset ( {P}_{i , l} , {P}_{j , m} )}{n}$$
avg_offset=offset by which a vehicle i can be aligned with a vehicle j at a timestamp tₖ
Oᵥ_{ᵢ}ₜ_{ₖ}=Vehicle i's observation at tₖ
V=vehicle j's trajectory in the vicinity
P_{i,l}=landmark point I observed by vehicle i at tₖ
P_{j,m}=landmark point m in the vicinity, observed by vehicle j
P_{i,l}, P_{j,m}=a determined matching pair calculated by local registration
n=the number of landmarks in Oᵥ_{ᵢ}ₜ_{ₖ}.

15. The system of claim 11, wherein determine an average offset based on the offsets between feature points includes determining the average offset is less than a predetermined offset threshold.

16. The system of claim 11, wherein determine matching feature points observed by each of the plurality of vehicles includes determining pairs of matching feature points observed by corresponding pairs of the plurality of vehicles.

17. The system of claim 11, wherein align the perception data by generating a factor graph includes using the average offset to represent a landmark offset relation between the plurality of vehicles.

18. A system comprising a processor and a non-transitory computer readable medium having instructions stored thereon for aligning multiple vehicle perception data, that upon execution by the processor, cause the processor to:
receive perception data observed by a plurality of vehicles, process the perception data to create feature points observed by the plurality of vehicles;
determine matching feature points observed by each of the plurality of vehicles;
determine an average offset between the matching feature points observed by each of the plurality of vehicles;
align the perception data by generating a factor graph using the average offset to represent a landmark offset relation between the plurality of vehicles;
update a map database with the aligned perception data; and
communicate updated map data to an autonomous vehicle for operation of the autonomous vehicle.

19. The system of claim 18, determine an average offset is below a predetermined threshold before align the perception data by generating the factor graph.

20. The system of claim 19, wherein the factor graph includes at least 3 constraints, including:
a pose of one of the plurality of vehicles is within a first predetermined distance from a GPS location of the one of the plurality of vehicles;
the pose of the one of the plurality of vehicles at each subsequent time stamp is withing a second predetermined distance from an original pose of the plurality of vehicles; and
an observed landmark is aligned with a landmark observed by another one of the plurality of vehicles.
